(19) United States
(12) Patent Application Publication
(10) Pub. No.: US 2005/0013932 A1
(43) Pub. Date: Jan. 20, 2005

(54) Method of forming heat resistant raised print from radiation curable solid particulate compositions

(76) Inventors: Derek J. Dennis, Atlanta, GA (US); Rosalyn M. Waldo, Woodstock, GA (US); Margaret A. Dulany, Atlanta, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/760,455

(22) Filed: Jan. 21, 2004

Related U.S. Application Data
(63) Continuation-in-part of application No. 10/622,189, filed on Jul. 18, 2003, now abandoned.

(51) Int. Cl. B05D 3/06

(52) U.S. Cl. 427/180; 427/558; 427/189; 427/195; 427/202; 427/375; 427/384; 427/385.5; 427/595

(57) ABSTRACT

A method of forming heat-resistant raised print on a substrate using a radiation-curable powder composition where the composition is cured using radiation. The powder composition includes one or more ultraviolet radiation curable (meth)acrylated polyester powders, and optionally one or more additives. The method includes applying the (meth)acrylated polyester powder composition to a wet inked print on a substrate to produce a coated print, heating the coated print to melt temperature to form a raised-melt, and irradiating the raised-melt to form the radiation-cured heat-resistant raised print on the substrate.

This is a continuation-in-part of U.S. application Ser. No. 10/622,189, filed Jul. 18, 2003.

### FIELD OF THE INVENTION

This invention relates to radiation curable, solid particulate, compositions and their use in the art of printing. The compositions include (meth) acrylated polyester powders.

### BACKGROUND OF THE INVENTION

Radiation-curable, acrylated epoxy polymer compositions have been used in various applications in non-particulate states as continuous coatings, films, and layers, with subsequent exposure to radiation.

Hyde, U.S. Pat. No. 5,565,246 discloses the use of a radiation-curable, solid particulate compositions that can be later cured by exposure to actinic radiation, for example, ultraviolet radiation or radiation generated by a high energy electron beam. The '246 compositions include acrylated polymers, acrylate-modified aminoamides and resins using sulfonium salts.

Prior art processes using thermoplastic resins include curing using heat. Following the inking of a substrate, usually a paper sheet, to represent for example, letters, the inked substrate is covered with a finely ground powder of thermoplastic resin. The resin employed is usually a dimer acid based polyamide polymer that is ground and sifted to a particle size suitable for the size of the print type to be coated. The powder adheres to the wet ink when deposited onto the substrate. Any excess powder can be removed from the substrate. The inked substrate is then heated to a sufficient temperature in order to melt the powder. The particles of the powder flow together to produce the raised print effect. The inked substrate is then cooled whereby the thermoplastic resin reverts back to a solid state and dries.

The present invention relates to an improvement in the process of Hyde, by using as the radiation-curable, solid particulate composition, a (meth)acrylated polyester powder. The resultant radiation-cured raised print produced exhibits excellent flexibility, high gloss, improved color, improved heat-stability, improved adhesion, reduced shrinkage and reduced yellowing. The powder compositions used in the present invention permits them to be used at a lower temperature than those disclosed in the prior art and hence permits one to obtain raised prints on more heat-sensitive substrates such as films. These lower temperatures also means that less energy is used and that less time is needed to heat and to cool the powder

The (meth)acrylated polyester powder compositions are suitable for use in laser printer, copier, web, and two-sided printing applications, and in lithographic, flexographic and thermographic printing applications.

### SUMMARY OF THE INVENTION

The invention provides an improved method of forming heat-resistant raised print from radiation-curable solid particulate compositions, including the steps of applying a wet inked print to a substrate; applying a radiation-curable (meth)acrylated polymer powder composition to the wet inked print on the substrate where the powder composition adheres to the wet inked print; heating the powder composition to melt temperature where the powder flows and fuses with the wet inked print to form a raised radiation-curable melt; and irradiating the melt where the melt polymerizes and forms a heat-resistant raised radiation-cured melt on the substrate. The improvement includes employing as the radiation-curable, acrylated polymer powder composition, a (meth)acrylated polyester powder including one or more (meth)acrylated polyester oligomers.

### DETAILED DESCRIPTION OF THE INVENTION

A. Definitions: The below definitions serve to provide a clear and consistent understanding of the specification and the claims, including the scope to be given such terms.

Substrate. By the term “substrate” is intended for the purposes of the invention, any substance capable of receiving ink, and/or any substance that requires ink, where the substance can be composed of any material capable of receiving ink, such materials including for example, paper, plastics, metals, composites, ceramics, and fabrics. Suitable substances include for example, any type of stationary including paper pages, letter head, envelopes, greeting cards, business cards, folders, labels, and covers; decorative objects including decorative prints, artwork, wrapping papers, and boxes; security products including lottery tickets, passports, and licenses; commercial paper including checks and money orders; paper products including paper plates, cups, napkins, towels, and packaging products including boxes, containers, and insert materials; books; fabric products including home goods, clothing, and fabric books; leather; wood; glass; plastic products including containers, toys, packaging products, sporting goods, and plastic wrap; metal products including foils, containers, packaging materials, and sheet metal. If necessary, the substrate may be treated prior to printing, to ensure adherence of the ink to the substrate. Such treating includes for example, surface modification using chemical or mechanical means. Such surface modification methods are known and can be readily selected, modified, and carried out, by the skilled artisan, without undue experimentation.

Printing or Print. By the term “printing or print” is intended for the purposes of the invention, the act of applying ink to a substrate, or the ink applied to the substrate. The ink may be in any pattern or form on the substrate, including for example letters, numbers, drawings, and symbols.

Ink. By the term “ink” is intended for the purposes of the invention, any pigmented composition capable of being applied to a substrate and forming under appropriate conditions, a raised surface. Suitable inks include for example thermographic inks, lithographic inks, flexographic inks, and screen inks. Any type or brand of ink can be used in thermographic printing, preferred are inks that stay open or tacky in order to catch and hold the powder composition thus providing sufficient “raise” with a smooth finish, if the ink is not sufficiently tacky, powder may be pulled off the ink during processing resulting in an uneven or “orange peel” finish. Most inks are designed to dry quickly, however one of skill in the art can readily modify drying characteristics for example by the addition of an overprinting varnish to achieve tack and open time, without undue experimentation. To catch more powder on the image areas, a higher than normal ink film thickness or build should be applied Suitable inks include those based on rubber, alkyds, hydrocarbons, phenolics, acrylated polyesters, acrylated epoxies, acrylated urethanes or a suitable combination.

(meth)acrylated polyester powder composition. By the term “(meth)acrylated polyester powder composition” is intended powders include any radiation curable (meth)acrylated polyester powder including for example, powders including of from 25 to 75 wt % (meth)acrylated epoxy oligomers and from 75 to 25 wt % (meth)acrylated polyester oligomers; preferably from 35 to 65 wt % (meth)acrylated epoxy oligomers and from 65 to 35 wt % (meth)acrylated polyester; more preferably from 45 to 55 wt % (meth)acrylated epoxy oligomers and from 55 to 45 wt % (meth)acrylated polyester; and most preferably powders including 50 wt % (meth)acrylated epoxy oligomers and 50 wt % (meth)acrylated polyester. Most preferred powder compositions include methacrylated polyesters in combination with acrylated epoxy oligomers. Specific suitable (meth)acrylated polyester powders include those disclosed in co-pending U.S. patent application Ser. No. 10/203,301 incorporated herein by reference in its entirety including UVECOAT® 3003 and UVECOAT® 3001. Also suitable for use is UVECOAT® 2300 (UCB Chemicals) which exhibits good adhesion to metal substrates.

Composition. By the term “composition” is intended for the purposes of the invention, the present radiation-curable acrylated polymer powder composition including suitable amounts of oligomers, the oligomers including (meth)acrylated polyester powder.

Additives. Other additives suitable for inclusion in the present composition include one or more plasticizers, especially radiation-sensitive plasticizers; one or more photo-initiators that absorb in the range of 180 to 600 nm; one or more photo-activators; one or more surface active agents; one or more binders, one or more stabilizing agents; additives that impart flexibility; one or more flow control additives for smoothing and/or leveling the coating and include any material that reduces surface tension of the powder particles as they melt; appearance additives including any material sufficient to improve a coating's appearance, for example bubble release and anti-popping agents, haze reducing agents, image improving agents; one or more fluidity regulating agents, and a degassing agent including degassing agents suitable for use in UV curable resins.

Preferred substrates include stationary, greeting cards or business cards.

Preferably, the (meth)acrylated polyester powder includes a radiation-sensitive oligomer including from 25 to 75 wt % (meth)acrylated epoxy oligomers and from 75 to 25 wt % (meth)acrylated polyester oligomers. The composition preferably includes a radiation-sensitive plasticizer in an amount of from 0 to 20 wt %, preferably 1 to 20 wt %. The plasticizer is preferably a semi-crystalline (meth)acrylated polyester, most preferably a semi-crystalline methacrylated polyester. Specific semi-crystalline methacrylated polyester in clued those commercialized under the name of UVECOAT® 9010 (UCB Chemicals). The radiation-curable solid particulate composition preferably has an average particle size of from 10 to 150 μm, from 30 to 100 μm, and of about 50 μm.

Preferably, in the method, irradiating includes irradiating with ultraviolet radiation, which is performed at a dose of from 0.5 to 3.0 J/cm², and preferably at a dose of from 1.0 to 2.5 J/cm².

The radiation-curable solid particulate composition may further includes one or more members of the group consisting of a photo-initiator, a flow-control agent, a radiation-sensitive plasticizer, a degassing agent, and an appearance additive.

Preferable radiation-curable solid particulate compositions include: UVECOAT® 3001 and UVECOAT® 3003 in an amount of from about 80 to about 90 wt %, UVECOAT® 9010 in an amount of from about 10 to about 20 wt %, a photoinitiator, especially alpha-hydroxyketone in an amount of from about 1.0 to about 3.0 wt %, flow control agent, especially polyacrylate copolymer in an amount of from about 0.5 to about 1.5 wt %, and degassing agents, such as benzoin or a derivative thereof in an amount of from about 0.2 to about 1.0 wt.

B. Formulations:

The inventive compositions are radiation-curable acrylated polymer powder compositions including suitable amounts of oligomers, the oligomers including (meth)acrylated polyester powders. The (meth)acrylated polyester powders preferably include from 15 to 85 wt % (meth)acrylated epoxy oligomers and from 85 to 15 wt % (meth)acrylated polyester; of from 25 to 75 wt % (meth)acrylated epoxy oligomers and from 75 to 25 wt % (meth)acrylated polyester; of from 35 to 65 wt % (meth)acrylated epoxy oligomers and from 65 to 35 wt % (meth)acrylated polyester; of from 45 to 55 wt % (meth)acrylated epoxy oligomers and from 55 to 45 wt % (meth)acrylated polyester; and powders including 50 wt % (meth)acrylated epoxy oligomers and 50 wt % (meth)acrylated polyester. Prefered are methacrylated polyesters in combination with acrylated epoxy oligomers.

Suitable (meth)acrylated polyester powders include those disclosed in copending U.S. patent application Ser. No. 10/203,301, incorporated herein by reference in its entirety, and includes:
a) 15 to 85 weight percentage of at least one (meth)acryloyl group containing amorphous polyester;
b) 15 to 85 weight percentage of at least one (meth)acryloyl group containing polyphenoxy resin; and
c) 0 to 20 weight percentage of at least one (meth)acryloyl group containing semi-crystalline polyester; each based on the total weight of the components a), b) and c).

Suitable inventive compositions include blends of the amorphous polyesters and the epoxy resins containing (meth)acryloyl groups optionally in combination with the semi-crystalline polyester containing (meth)acryloyl groups.

The inventive composition may also include one or more additives including for example, one or more radiation-sensitive plasticizers; one or more viscosity additives, one or more photo-initiators which absorb in the range of 180 to 600 nm, and include known photo-initiators including for example aromatic carbonyl compounds including benzophenone and its alkylated or halogenated derivatives, anthraquinone and its derivatives, thioxanthone and its derivatives, benzoin ethers, aromatic or non-aromatic alphadiones, benzyl dialkyl acetals, acetophenone derivatives, aromatic ketones, and phosphine oxide, for use in an amount sufficient to initiate polymerization, a suitable photo-initiator is IRGACURE® 2959 (Ciba) which is alpha-hydroxyketone; one or more photo-activators; one or more surface active agents; one or more binders, one or more stabilizing agents; one or more additives that impart flexibility including for example acrylated urethanes for use in an amount of from 0 to 30 wt % based on the weight of the additives; one or more flow control additives for smoothing and/or leveling the coating and include any material that reduces surface tension of the powder particles as they melt and include for example silicones and polyacrylates, polyacrylates including polyacrylate copolymer and polyacrylate polymer, suitable polyacrylate copolymer is preferably BYK® 361 (BYK Chemie), and suitable polyacrylate polymers include BYK® 356 (BYK Chemie), such polymer and copolymer can be used in an amount sufficient to impart desired leveling/smoothing and flexibility effects while avoiding tackiness of the surface of the coating, for example in an amount of from 0.3 to 2.0 wt %, from 0.5 to 1.5 wt %, and in an amount of 1.0 wt %, based on total composition weight, suitable silicones include polyether and polyester-modified poly-siloxanes (the use of such silicones provided on silica particles is to be avoided because silica imparts a haze to clear coats); one or more appearance additives including any material sufficient to improve a coating's appearance, for example bubble release and anti-popping agents, haze reducing agents, image improving agents, suitable appearance additives include for example benzoin which reduces haze, improves image distinctness, promotes flow, and functions as a bubble release and anti-popping agent, preferred appearance additives include OXYMELT A-4® (Estron Chemical), BENZOFLEX 352® (Velsicol Chem), SULFONYL P-200® (Air Products), MODAREX 29-079B® (Synthron), and POWDERMATE EX 542® (Troy), for use in an amount sufficient to improve desired appearance properties, for example in an amount of 0 to 1.0 wt % of the composition, from 0.2 to 0.8 wt % and in an amount of about 0.4 wt %; one or more fluidity regulating agents including for example RESIFLOW PV5® (Worlee Chemie) and one or more degassing agents including degassing agents suitable for use in UV curable resins, for example OXYMELT A-4® (Estron Chemical), for use in an amount sufficient to degas the inventive composition, for example in an amount of 0 to 1.0 wt % of the composition, from 0.2 to 0.8 wt % and in an amount of about 0.4 wt %.

Preferred additives include one or more photo-initiators, one or more flow control additives, one or more appearance additives, and/or one or more degassing agents, and/or any combination thereof. Generally, UVECOAT® resins do not require the use of a separate hardener.

Preferred (meth)acrylated polyester powders include one or more of UVECOAT® 3003 and UVECOAT® 3001 (UCB Chemicals), more preferably in combination with UVECOAT® 9010. UVECOAT® 9010 is a semi-crystalline polyester characterized by a melting point of 80 to 85° C. and a low viscosity.

Specific preferred inventive compositions include (note: weight % (wt %) is based upon total weight of the composition unless otherwise stated):

(i) UVECOAT® 3003, IRGACURE® 2959, BYK® 361, OXYMELT A-4®, and UVECOAT® 9010. Preferably UVECOAT® 3003 is present in the composition in an amount of from 50 to 99 wt %, from 75 to 85 wt % and in an amount of about 83 wt %. IRGACURE® 2959 is present in the composition in an amount of from 0 to 5 wt %, from 0.5 to 3.0 wt %, from 1.0 to 2.5 wt %, and in an amount of about 2.0 wt %. BYK® 361 is present in the composition in an amount of from 0 to 3 wt %, from 0.5 to 2.0 wt %, from 0.7 to 1.5 wt %, and in an amount of about 1.0 wt %. OXYMELT A-4® is present in the composition in an amount of from 0 to 1.5 wt %, from 0.1 to 1.0 wt %, from 0.2 to 0.7 wt %, and in an amount of about 0.5 wt %. UVECOAT® 9010 is present in the composition in an amount of from 4 to 25 wt %, from 8 to 20 wt %, from 12 to 17 wt %, and in an amount of about 15 wt %.

Preferred examples of the above composition (i) are UVECOAT® 3003 in an amount of from about 80 to about 90 wt %, UVECOAT® 9010 in an amount of from about 10 to about 19 wt %, α-hydroxyketone in an amount of from about 1.0 to about 3.0 wt %, polyacrylate copolymer in an amount of from about 0.5 to about 1.5 wt %, and benzoin or a derivative thereof in an amount of from about 0.2 to about 1.0 wt %. UVECOAT® 3003 in an amount of 82.1 wt %, α-hydroxyketone for example, IRGACURE® 2959 in an amount of 2.0 wt %, benzoin or a derivative thereof for example, BYK® 361 in an amount of 1.0 wt %, polyacrylate copolymer for example, OXYMELT A-4 ® in an amount of 0.4 wt %, and UVECOAT® 9010 in an amount of 14.5 wt %.

(ii) UVECOAT® 3003, IRGACURE® 2959, BYK® 361, and OXYMELT A-4®. Preferably UVECOAT® 3003 is present in the composition in an amount of from 50 to 99 wt %, from 75 to 85 wt % and in an amount of about 83 wt %. IRGACURE® 2959 is present in the composition in an amount of from 0 to 5 wt %, from 0.5 to 3.0 wt %, from 1.0 to 2.5 wt %, and in an amount of about 2.0 wt %. BYK® 361 is present in the composition in an amount of from 0 to 3 wt %, from 0.5 to 2.0 wt %, from 0.7 to 1.5 wt %, and in an amount of about 1.0 wt %. OXYMELT A-4® is present in the composition in an amount of from 0 to 1.5 wt %, from 0.1 to 1.0 wt %, from 0.2 to 0.7 wt %, and in an amount of about 0.5 wt %.

An example of the above composition (ii) is UVECOAT® 3003 in an amount of 96.6 wt %, IRGACURE® 2959 in an amount of 2.0 wt %, BYK® 361 in an amount of 1.0 wt %, and OXYMELT A-4® in an amount of 0.4 wt %.

(iii) UVECOAT® 3001, IRGACURE® 2959, BYK® 361, and OXYMELT® A-4. Preferably UVECOAT® 3001 is present in the composition in an amount of from 50 to 99 wt %, from 75 to 85 wt % and in an amount of about 83 wt %. IRGACURE® 2959 is present in the composition in an amount of from 0 to 5 wt %, from 0.5 to 3.0 wt %, from 1.0 to 2.5 wt %, and in an amount of about 2.0 wt %. BYK® 361 is present in the composition in an amount of from 0 to 3 wt %, from 0.5 to 2.0 wt %, from 0.7 to 1.5 wt %, and in an amount of about 1.0 wt %. OXYMELT A-4® is present in the composition in an amount of from 0 to 1.5 wt %, from 0.1 to 1.0 wt %, from 0.2 to 0.7 wt %, and in an amount of about 0.5 wt %.

An example of the above composition (iii) is UVECOAT® 3001 in an amount of 96.6 wt %, IRGACURE® 2959 in an amount of 2.0 wt %, BYK® 361 in an amount of 1.0 wt %, and OXYMELT A-4® in an amount of 0.4 wt %.

(iv) UVECOAT® 3001, IRGACURE® 2959, BYK® 361, OXYMELT A-4®, and UVECOAT® 9010. Preferably UVECOAT® 3001 is present in the composition in an amount of from 50 to 99 wt %, from 75 to 85 wt % and in an amount of about 83 wt %. IRGACURE® 2959 is present in the composition in an amount of from 0 to 5 wt %, from 0.5 to 3.0 wt %, from 1.0 to 2.5 wt %, and in an amount of about 2.0 wt %. BYK® 361 is present in the composition in an amount of from 0 to 3 wt %, from 0.5 to 2.0 wt %, from 0.7 to 1.5 wt %, and in an amount of about 1.0 wt %. OXYMELT A-4® is present in the composition in an amount of from 0 to 1.5 wt %, from 0.1 to 1.0 wt %, from 0.2 to 0.7 wt %, and in an amount of about 0.5 wt %. UVECOAT® 9010 is present in the composition in an amount of from 4 to 25 wt %, from 8 to 20 wt %, from 12 to 17 wt %, and in an amount of about 15 wt %.

Preferred examples of the above composition (iv) are UVECOAT® 3001 in an amount of from about 80 to about 90 wt %, UVECOAT® 9010 in an amount of from about 10 to about 20 wt %, alpha-hydroxyketone in an amount of from about 1.0 to about 3.0 wt %, polyacrylate copolymer in an amount of from about 0.5 to about 1.5 wt %, and benzoin or a derivative thereof in an amount of from about 0.2 to about 1.0 wt %. UVECOAT® 3001 in an amount of 82.1 wt %, alpha-hydroxyketone for example, IRGACURE® 2959 in an amount of 2.0 wt %, benzoin or a derivative thereof for example, BYK® 361 in an amount of 1.0 wt %, polyacrylate copolymer for example, OXYMELT A-4® in an amount of 0.4 wt %, and UVECOAT® 9010 in an amount of 14.5 wt %.

UVECOAT® 9010 is semi-crystalline methacrylated polyester.

UVECOAT® 3001 is 50 wt % methacrylated polyester, 50 wt % acrylated epoxy.

UVECOAT® 3003 is 50 wt % methacrylated polyester and 50 wt % acrylated epoxy.

Preferably, the powders are prepared by dry mixing the (meth)acryloyl group containing resins, the photo-initiator and optionally the (meth)acryloyl group containing semi-crystalline polyester, with and other various additional substances conventionally used for the manufacture of powder coatings. The mixture obtained is them homogenized at a temperature of approximately 70 to 140° C. in a Prism 16 mm (Ll/D=15/1) twin screw extruder and the extrudate is ground in a grinder. The resultant powder is then sieved to obtain a particle size of from 10 to 110 micrometer.

C. Application and Curing:

The application and curing process, for curing the present (meth)acrylated polyester powder compositions, is preferably carried out in two steps, including a heating step and a curing step, where the heating step is preferably carried out under conditions sufficient to produce a raised melt. Such conditions include heat temperature, heat time and optionally humidity. The steps of heating and curing may each be performed as a single step, or may include multiple steps. For example, heating can be carried out at a first temperature using a first method for a first amount of time, followed by heating at a second temperature using the same or a different method for the same or a different amount of time, where the heating steps are performed uninterrupted, or are performed with a delay between steps.

Suitable heat temperatures include heat temperatures of less than or equal to 150° C., preferably less than 140° C., less than 120° C., and less than 100° C. More specifically, at temperatures of from about 50° C. to about 140° C., and from about 90° C. to about 140° C., from about 50° C. to about 100° C., and from about 50° C. to about 80° C.

Heating is carried out for a time period sufficient to produce a raised melt, for example, from about 1 second to about 60 minutes, from about 20 to about 200 seconds, and from about 30 to about 150 seconds. The period of time selected depends on the method of heating employed, the temperature employed, and the amount of moisture present. Generally, the higher the temperature, the shorter the time period.

Suitable heating methods include any method and/or apparatus capable of heating the powder coated substrate to melt the powder, whereby the melted powder coalesces forming a film, to form a raised-melt. Suitable heating methods include the use of infrared radiation, an incubator, and a convection oven, and/or any combination thereof.

Preferably, heating is carried out using a combination of IR and convection for a time period of from 1 to 2 minutes.

The curing step includes irradiating the raised-melt with ultraviolet radiation under conditions sufficient to polymerize the melt and form a heat-resistant raised print on the substrate. Such conditions include UV line speed, UV dose, and cure time period.

Suitable line speeds include speeds in the range of from 4 to 100 feet per minute (fpm) and 10 to 90 fpm.

Suitable UV radiation doses include doses in the range of from 0.5 to 10.0 J/cm², from 1.0 to 6.5 J/cm², from 1.2 to 6.0 J/cm², from 1.4 to 5.0 J/cm² , and from 1.0 to 3.0 J/cm². Suitable cure time periods are from 1 to about 60 seconds.

Preferably, curing is carried out using UV radiation for a period of seconds, thus resulting in a total heating and curing time of from one to three minutes.

The present method is generally performed by preparing the (meth)acrylated polyester powder compositions by methods including those set forth in co-pending U.S. patent application Ser. No. 10/203,301.

A wet inked substrate is prepared by methods known in the art. The powder composition is then applied to the wet inked substrate, for example, by electrostatically spraying the powder composition onto the wet inked substrate to produce a coated substrate.

Preferably, the powder is coated to a film thickness of from about 30 to about 110 micrometer, more preferably from about 40 to about 100 micrometer. The coated substrate is then heated to produce a raised-melt. The coated substrate is heated to a temperature so that the powder flows and fuses with the wet inked print on the substrate, thus producing the raised-melt. For example, after coating, the coated substrate enters the heating means, for example, an oven at an appropriate temperature, for example at from 50 to 100° C., where the powder then coalesces forming a film. Generally, this step lasts from about 30 to about 150 seconds. Lastly, the molten film is cured by irradiating using UV radiation, for a time period in the range of seconds.

Electrostatic spraying can be carried out using a corona discharge electrostatic spray gun (70 kV) or a tribo charging gun (if a tribo gun is employed, the addition of a tribo additive to the composition is preferred).

### EXAMPLES

### Example 1

Inventive composition formulations including (meth)acrylated polyester powders, are prepared and are set forth in Table 1 below.

TABLE 1

| | UVECOAT ® | UVECOAT ® | UVECOAT ® | IRGACURE ® | BYK ® | OXYMELT |
|---|---|---|---|---|---|---|
| | 3001 | 3003 | 9010 | 2959 | 361 | A-4 ® |
| COMPOSITION | (In weight percent based on total weight of the composition) | | | | | |
| 1 | — | 82.1 | 14.5 | 2.0 | 1.0 | 0.4 |
| 2 | — | 96.6 | — | 2.0 | 1.0 | 0.4 |
| 3 | 96.6 | — | — | 2.0 | 1.0 | 0.4 |
| 4 | 82.1 | — | 14.5 | 2.0 | 1.0 | 0.4 |

For each composition, eight sheets of paper (substrate) are printed with flexographic ink. Each set of sheets is then covered with the powder composition 1, 2, 3, or 4, to yield a sample size of thirty-two sheets, where the sheets are covered with powder using an electrostatic spray technique. Excess powder is removed from the sheets and the sheet samples are cured as set forth below in Table 2 (In this Table, IR stands for infra-red and IC for induction cure).

TABLE 2

| Composition(Sample) | Heat | time | UV dose | speed |
|---|---|---|---|---|
| 1(A) | IR | 5 sec | 2 J/cm² | 14 fpm |
| 1(B) | IR | 3 sec | 2 J/cm² | 14 fpm |
| 1(C) | IC 50° C. | 10 min | 2 J/cm² | 14 fpm |
| 1(D) | IC 50° C. | 10 min | — | |
| 1(E) | IC 53.4° C. | 60 min | 1.4 J/cm² | 20 fpm |
| 1(F) | (heating by UV lamps only) | | 6 J/cm² | 3 fpm |
| 1(G) | IC 60° C. | 1 min, then | 1.4 J/cm² | 20 fpm |
| | IC 130° C. | 20 sec | | |
| 1(H) | IC 53.4° C. | 6 min | 1.4 J/cm² | 20 fpm |
| 2(A) | IR | 5 sec | 2 J/cm² | 14 fpm |
| 2(B) | IR | 3 sec | 2 J/cm² | 14 fpm |
| 2(C) | IC 50° C. | 10 min | 2 J/cm² | 14 fpm |
| 2(D) | IC 50° C. | 10 min | — | |
| 2(E) | IC 53.4° C. | 60 min | 1.4 J/cm² | 20 fpm |
| 2(F) | (heating by UV lamps only) | | 6 J/cm² | 3 fpm |
| 2(G) | IC 60° C. | 1 min, then | 1.4 J/cm² | 20 fpm |
| | IC 130° C. | 20 sec | | |
| 2(H) | IC 53.4° C. | 6 min | 1.4 J/cm² | 20 fpm |
| 3(A) | IR | 5 sec | 2 J/cm² | 14 fpm |
| 3(B) | IR | 3 sec | 2 J/cm² | 14 fpm |
| 3(C) | IC 50° C. | 10 min | 2 J/cm² | 14 fpm |
| 3(D) | IC 50° C. | 10 min | — | |
| 3(E) | IC 53.4° C. | 60 min | 1.4 J/cm² | 20 fpm |
| 3(F) | (heating by UV lamps only) | | 6 J/cm² | 3 fpm |
| 3(G) | IC 60° C. | 1 min, then | 1.4 J/cm² | 20 fpm |
| | IC 130° C. | 20 sec | | |
| 3(H) | IC 53.4° C. | 6 min | 1.4 J/cm² | 20 fpm |
| 4(A) | IR | 5 sec | 2 J/cm² | 14 fpm |
| 4(B) | IR | 3 sec | 2 J/cm² | 14 fpm |
| 4(C) | IC 50° C. | 10 min | 2 J/cm² | 14 fpm |
| 4(D) | IC 50° C. | 10 min | — | |
| 4(E) | IC 53.4° C. | 60 min | 1.4 J/cm² | 20 fpm |
| 4(F) | (heating by UV lamps only) | | 6 J/cm² | 3 fpm |
| 4(G) | IC 60° C. | 1 min, then | 1.4 J/cm² | 20 fpm |
| | IC 130° C. | 20 sec | | |
| 4(H) | IC 53.4° C. | 6 min | 1.4 J/cm² | 20 fpm |

After heating and curing, the above samples are evaluated on the basis of cure, flexibility, finish (gloss, surface imperfections), shrinkage, color and heat stability. Overall, composition 1 exhibits the most favorable characteristics, i.e., excellent cure and flexibility, good finish having a high gloss, minimal shrinkage, good color and very good heat stability (“cure” is defined as the adhesion of the coating to the paper after cure; “flexibility” is defined as the ability of the coating to adhere to the substrate while folding the substrate in half; by “good finish”, it is intended that the coating is not hazy and has no craters or pinholes; “shrinkage” is determined by the amount of curling done to the substrate after cure; “color” is defined has the general clearness or yellowness of the coating; “heat stability” is determined by applying an heated iron to the coating after a sheet of paper has been placed above the cured product and is considered as very good if the paper will not stick to the product after the iron has been applied for 10 seconds).

### Example 2

Inventive powder composition 1 was prepared as set forth in Example 1. Sheets of paper (substrate) were printed with ink. The wet inked substrate was then covered with the powder composition 1 by electrostatically spraying the powder composition onto the wet inked substrate to produce a coated substrate. Excess powder was removed from the sheets. The coated substrate was then heated to produce a raised-melt. The coated substrate was heated to a temperature so that the powder flowed and fused with the wet inked print on the substrate, thus producing the raised-melt. The molten film was cured by irradiating using UV radiation, for a time period in the range of seconds.

The cured samples were then evaluated on a scale of 1 to 5, with 5 being excellent and 1 being poor. The results are set forth in Table 3 below.

TABLE 3

| | Property | Score | Comments |
|---|---|---|---|
| Comp. 1 | cure | 4.5 | excellent gloss, several pinholes |
| | flexibility | 5.0 | paper did curl, yet tips did not touch |
| | finish | 3.5 | |
| | shrinkage | 3 | |
| | color | 4 | |
| | heat stability | 4 | |

It will be appreciated by those skilled in the art to which the invention pertains that various modifications can be made without departing from the essential nature thereof. It is intended to encompass all such modification within the scope of the appended claims.

1-9. (Canceled)

10. In a method of forming heat-resistant raised print, comprising the following steps in the order named:
a) applying a wet inked print to a substrate;
b) applying a radiation-curable acrylated polymer powder composition, including plasticizer, to the wet inked print on the substrate, whereby the powder composition adheres to the wet inked print;
c) heating the powder to melt temperature, whereby the powder composition flows and fuses with the wet inked print to form a raised radiation-curable melt; and
d) irradiating the raised radiation-curable melt whereby the raised radiation-curable melt polymerizes and forms a heat-resistant raised radiation-curable melt on the substrate,
the improvement which comprises employing, as a plasticizer, a radiation-sensitive, semi-crystalline polyester containing (meth)acryloyl groups.

11. The method according to claim 10, wherein said radiation-curable polymer powder composition further contains (meth)acrylated epoxy oligomers and (meth)acrylated polyester oligomers.

12. The method according to claim 11, wherein the (meth)acrylated epoxy oligomers are present at 25 to 75 wt % and the (meth)acrylated polyester oligomers are present at 75 to 25 wt %.

13. The method according to claim 12, wherein the (meth)acrylated epoxy oligomers are present at 50 wt % and the (meth)acrylated polyester oligomers are present at 50 wt %.

14. The method according to claim 10, wherein said radiation-curable acrylated polymer powder composition further comprises one or more members selected from the group consisting of photo-initiators, flow control agents, appearance agents and degassing agents.

15. The method according to claim 10, wherein the radiation-sensitive plasticizer is present in an amount of from about 1 to about 20 wt %.

16. The method according to claim 10, wherein said irradiating is performed with ultraviolet radiation.

17. The method according to claim 10, wherein said substrate comprises paper.

18. The method according to claim 17, wherein said paper is stationary, greeting cards or business cards.

19. The method according to claim 10, wherein step c) is performed at a temperature below 150° C.

20. The method according to claim 19, wherein said temperature is from about 50° C. to about 80° C.
